(19) United States
(12) Patent Application Publication
(10) Pub. No.: US 2012/0006761 A1
(43) Pub. Date: Jan. 12, 2012

(54) ABSORBENT MATERIAL AND METHOD FOR USING SAME

(76) Inventors: Andrew Parker, Diamond, MO (US); Travis Turek, Grand Island, NE (US)

(21) Appl. No.: 13/177,624

(22) Filed: Jul. 7, 2011

Related U.S. Application Data
(60) Provisional application No. 61/362,112, filed on Jul. 7, 2010.

(51) Int. Cl. B01D 29/00

(52) U.S. Cl. 210/767; 210/483

(57) ABSTRACT

An absorbent material is provided for collecting lipophilic and hydrophobic materials from an aqueous solution such as water. The material comprises nonwoven polyester fibers in the form a mat. The mat may include reinforcing strands, such as glass fiber, nylon fiber, metallic wire and the like in order to increase its overall strength. A system and method for removing lipophilic and hydrophobic materials, such as oil, from a body of water are also provided. The system and method employs one or more floating vessels having a roll of the material thereon that is placed in the oil-water mixture. Upon absorbing oil from the water, the material is removed from the water.

### CROSS-REFERENCE TO RELATED APPLICATIONS

This Application claims priority to U.S. Provisional Patent Application Ser. No. 61/362,112 filed Jul. 7, 2010 to Andrew Parker and Travis Turek entitled “Absorbent Material and Method For using Same,” currently pending, the entire disclosure of which is incorporated herein by reference.

### BACKGROUND OF THE INVENTION

Oil spills from offshore drilling operations and vessels transporting oil can result in environmental catastrophes that cause serious adverse impacts on wildlife and marine life and cost hundreds of millions of dollars of damage to clean and remediate. As offshore drilling operations continue and the transportation of oil between continents remains prevalent, these oil spills continue to be problematic.

Numerous materials and methods have been proposed for removing oil from a body of water. The materials have included cellulosic materials, such as saw dust, straw, rice hulls, pulp, peat and cotton, various inorganic materials and various synthetic fiber materials. While these known materials may be suitable for some applications, they are not free from downfalls, such as low tensile strength and/or prohibitively high cost. Thus, a need exists for a material and method for absorbing oil, particularly large quantities of oil from water, which is sufficiently inexpensive and efficiently strong.

### SUMMARY OF THE INVENTION

One embodiment of the present invention is directed to an absorbent material for collecting lipophilic and hydrophobic materials from an aqueous solution such as water. The absorbent material may comprise nonwoven polyester fibers in the form a mat. The fibers may be spunbound and may be compressed or needle punched. The mat can include reinforcing strands, such as glass fiber, nylon fiber, metallic wire and the like in order to increase its overall strength.

Another embodiment of the present invention is directed to a system for removing lipophilic and hydrophobic materials from a body of water. The system includes first and second vessels floating in the water and a nonwoven polyester material formed in a roll located on the first vessel and configured to be placed into the water. Upon absorbing the lipophilic and/or hydrophobic materials from the water, the material may be removed from the water and placed on one of the first and second vessels.

A further embodiment of the present invention is directed to a method for removing lipophilic and hydrophobic materials from a body of water. The method comprises the steps of providing a nonwoven polyester material in a roll, providing a first floating vessel having a roll of the material located thereon, unwinding the roll and placing the material in the water, removing the material from the water after the material has absorbed at least a portion of the lipophilic and/or said hydrophobic materials from the water, and placing the material on one of the first and second floating vessels.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is an enlarged schematic view of a mat of material in accordance with one embodiment of the present invention;

FIG. 2 is a side perspective view illustrating a method and material for recovering oil from an oil spill in accordance with one embodiment of the present invention;

FIG. 3 is a side perspective view illustrating another method and material for recovering oil from an oil spill in accordance with one embodiment of the present invention; and

FIG. 4 is a side perspective view illustrating a further method and material for recovering oil from an oil spill in accordance with one embodiment of the present invention.

### DETAILED DESCRIPTION OF THE INVENTION

The present invention involves the provision of an absorbent material 10 and a method for using the same. The invention can be used to separate lipophilic and/or hydrophobic materials from an aqueous medium or absorb such materials from solid and flexible surfaces, as discussed in further detail herein.

In one embodiment, the material 10 is a spun bonded or nonwoven hydrophobic material adapted for absorbing oil 14, oil-like liquids, lipophilic substances and the like floating atop water. The material 10 may be a geotextile membrane. The material 10 may be formed of a number of different substances or materials and may be constructed of a plurality of fibers or filaments 12. In one embodiment, the material 10 includes a polymer, such as polyester, and is in the form of a mat.

The material and mat may be manufactured using the system and method described in U.S. Patent Application Publication No. 2005/0233667 entitled System and Method for Manufacturing Polymer Mat with Reduced Capacity Spinning Pumps, the entire disclosure of which is incorporated herein by reference. A polyester non-woven mat of material may be produced by crystallizing and drying polyester chips and introducing them to an extruder that presents melted polyester to spinning pumps. The pumps push the polyester material through spinning packs that produce filaments 12 that are stretched using compressed air. The cooled and stretched polyester filaments 12 can be deposited over a web belt or conveyor in order to form a homogeneous sheet that is needled on both sides creating a cloth material. Additionally or alternatively, the sheet of filaments may be passed through an entangler which can be in the form of one or more compression rollers. The sheet can then be presented to a hot calendar that sets the sheets thickness and prepares the sheet for thermal setting and cold calendaring which enhances the sheets dimensional stability. The sheet may be soaked in a latex suspended resin and dried in ovens and sent through a final cold calendaring giving the polyester non-woven mat its final quality and physical characteristics.

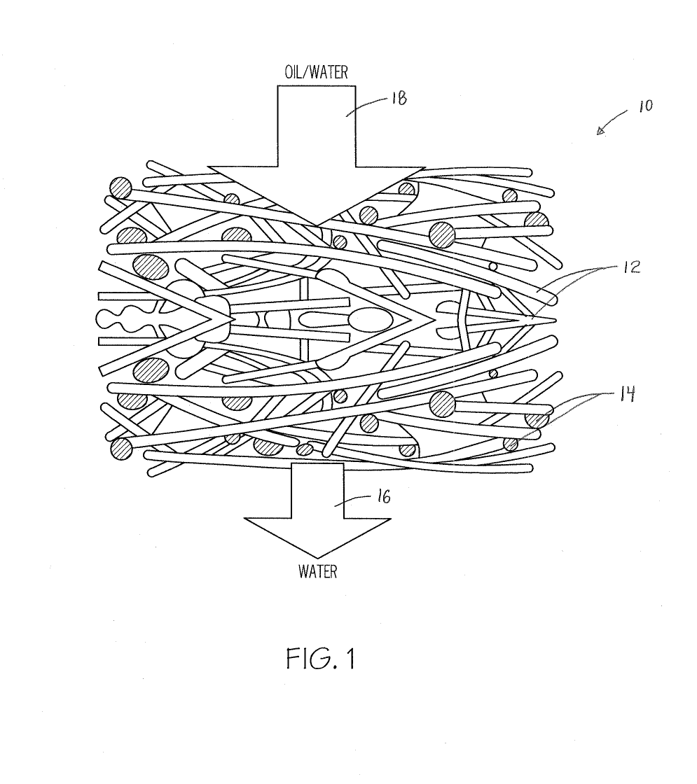

The resulting material 10 is generally hydrophobic and, therefore, selectively absorbs lipophilic and/or hydrophobic materials (e.g., oil, oil-like liquids, etc.) 14 from water 16. As demonstrated in FIG. 1, water 16 may pass through the material 10 while the lipophilic and hydrophobic materials 14 are retrained within the material 10. This results in the material 10 having the ability to absorb a high concentration of oil as compared to water. The material 10 may be constructed with or without a “binder,” as is typically used in the construction of roofing products, such as asphalt-saturated nonwoven polyester roofing membranes, and other geotextile materials.

The material 10 may be configured into any desirable configuration for skimming the water's surface. For example, it can be configured into rolls, sheets, continuous sheets, strips or the like that may be pulled by a boom attached to a boat or barge floating in a body of water. As the material 10 absorbs oil 14, the material 10 maintains a tendency to float at or near the water's upper surface since the oil 14 the material 10 has absorbed has a lower specific gravity than water.

In one embodiment the material 10 is reusable. Once the material 10 is saturated with oil 14, it can be squeezed or wrung out, for example between pinch rollers, in order to remove the oil 14 contained therein. The oil that is removed from the material 10 can be collected and used as a fuel or used to produce petroleum-based products. After some or all of the oil 14 has been removed from the material 10, the material 10 can be reused and may continue to collect oil from the water.

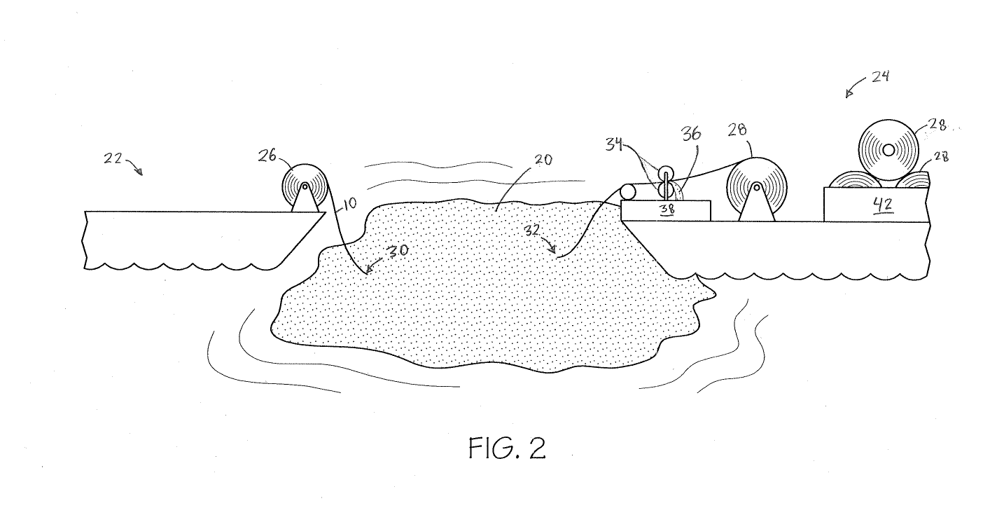

The present invention is also directed to a method for absorbing hydrophobic and lipophilic materials using the geotextile membrane. FIGS. 2-4 illustrate various methods for using the material 10 to absorb oil from the surface of a body of water. As shown, the material 10 may be wound in a roll 26 and placed on a barge, boat or other vessel 22 located in a body of water. The material 10 may be taken from the roll 26 and placed in the surrounding water, which may have oil floating on its surface in the form of an “oil slick” 20. While in the water, the material 10 absorbs the oil and oil-like materials.

In the embodiment illustrated in FIG. 2, the material 10 is continuously unwound into the surrounding water from a first barge 22 and rewound onto a roll 28 located on a second barge 24. The roll 26 of material located on the first barge 22 is a roll of new or clean material suitable for absorbing oil 14. The material 10 from the first roll 26 contacts the surface of the oil-water mixture or oil slick 20 at a location 30. The material 10 may generally float on the surface of the oil slick 20 or may be located therebelow until it loses contact with the oil slick at a location 32 as it is removed from the body of water. The material 10, which has absorbed oil 14, is then removed from the body of water and run through squeeze rollers 34 located on the second barge 24 in order to remove some or all of the oil 14 from the material 14. As shown, the oil 14 removed from the material 10, illustrated at 36, is diverted into a receptacle 38 and may be later recycled or re-used. The material 10 is then rewound onto a roll 28 that can then be reused to remove more oil from the water. The rolls 28 of material 28 may be stored in a receptacle 42 until the barge 24 reaches shore or until they are reused. The rolls 28 of material may be re-used or may be burned and used as an energy source or fuel. The barges 22 and 24 depicted in FIG. 2 may move together in forward, backward or sideways directions, as desired, in order to form a skim line across the oil slick 20.

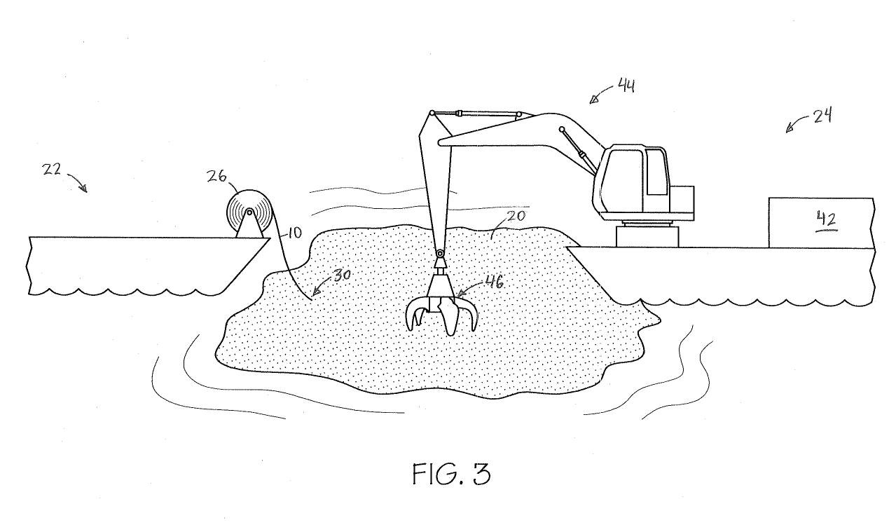

In another embodiment, as shown in FIG. 3, the material 10 is unwound from a roll 26 located on the first barge 22 and placed in the oil-water mixture 20. The material 10 may be unwound continuously or in segments creating separate sheets of material. After the material 10 has been in the water for a sufficient duration of time to absorb oil, the material 10 can be picked up out of the water with a crane 44 having a claw attachment 46 connected thereto. The oil-soaked material 10 can then be placed on the second barge 24, where it may be rewound or may be gathered in receptacle 42 until it is deposited inland where it can be burned and used as an energy source or fuel.

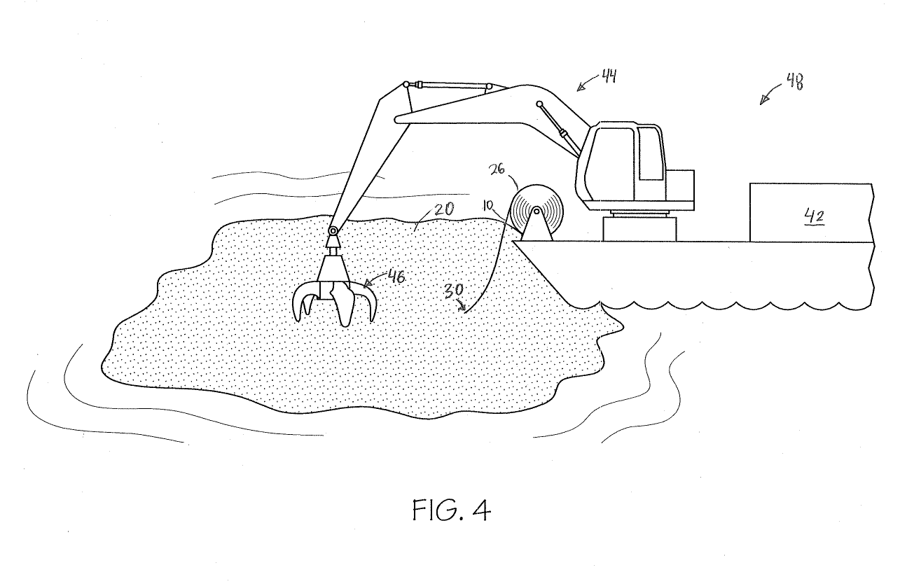

FIG. 4 illustrates yet another embodiment wherein only a single barge 48 or other vessel is required. As shown, the material 10 is unwound from a roll 26 located on the barge and is placed into the oil-water mixture 20. The material 10 may be unwound continuously or in segments creating separate sheets of material. After the material 10 has been in the water for a sufficient duration of time to absorb oil, the material 10 is picked up out of the water with a crane 44 having a claw attachment 46 connected thereto. The oil-soaked material 10 can then be placed on the barge 48, where it may be rewound or may be gathered in receptacle 42 until it is deposited inland where it can be burned and used as an energy source or fuel.

Removal of the soaked material 10 from the water may potentially create problems due to the combined weight of the material 10 and oil 14 exceeding the tensile strength of the material 10. In order to better facilitate the removal of the oil soaked material 10 from the water, a number of methods may be employed, including but not limited to, incorporating reinforcing strands with the material 10. The reinforcing strands, which may be incorporated during or after the production of the material 10, may comprise of glass fiber, nylon fiber, metallic wire and the like. Alternatively, or in addition to the reinforcing strands, the material may be lifted from the water using a crane 44 or hoist.

It will be appreciated by one of skill in the art that the material 10 described herein need not be used in water, and may additionally be used as a wipe or sponge to absorb oil 14, oil-like liquids, lipophilic substances and the like from any number of objects or substrates such as those having flexible or solid surfaces. Those objects may include, but are in no way limited to, humans, animals, plants, clothing, boats, automobiles, sand, soil, rocks, minerals, and concrete or asphalt surfaces among countless others. For example, the material 10 may be used to absorb oil 14 and tar balls that have found their way onto beaches. The material 10 may also be utilized as a filter and can be used in applications where it is desired to separate lipophilic and/or hydrophobic materials from a flowing medium, including for example, water flowing in a channel or pipe.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. An absorbent material for collecting at least one of a lipophilic material and a hydrophobic material from an aqueous solution, wherein said absorbent material comprises nonwoven polyester in the form of a mat.

2. The absorbent material of claim 1 wherein said absorbent material comprises fibers of nonwoven polyester.

3. The absorbent material of claim 1 wherein said mat is a spunbound fibrous mat.

4. The absorbent material of claim 3 wherein said fibrous mat is compressed or needle punched.

5. The absorbent material of claim 1 wherein said absorbent material further comprises reinforcing strands.

6. The absorbent material of claim 5 wherein said reinforcing strands include strands of fiberglass.

7. A system for removing at least one of a lipophilic material and a hydrophobic material from an aqueous solution, said system comprising:
a first structure floating in the aqueous solution; and
a nonwoven polyester material, said polyester material being formed in a roll located on said first structure and configured to be placed in said aqueous solution;
wherein upon absorbing at least one of said lipophilic and hydrophobic materials from said aqueous solution, said polyester material may be removed from said aqueous solution and placed on one of said first structure and a second structure floating in the aqueous solution.

8. The system of claim 7 wherein said nonwoven polyester material comprises a plurality of fibers in the form of a mat.

9. The system of claim 8 wherein said mat is a spunbound fibrous mat.

10. The system of claim 9 wherein said mat is compressed or needle punched.

11. The system of claim 8 wherein said mat comprises reinforcing strands.

12. A method for removing at least one of a lipophilic material and a hydrophobic material from an aqueous solution, said method comprising the steps of:
providing a nonwoven polyester material in a roll;
providing a first structure floating in the aqueous solution, said roll of polyester material being located on said first structure;
unwinding said roll and placing said polyester material in said aqueous solution;
removing said polyester material from said aqueous solution after said polyester material has absorbed at least a portion of at least one of said lipophilic material and said hydrophobic material from said aqueous solution; and
placing said polyester material on one of said first structure and a second structure floating in the aqueous solution.

13. The method of claim 12 wherein said nonwoven polyester material comprises a plurality of fibers in the form of a mat.

14. The system of claim 13 wherein said mat is a spunbound fibrous mat.

15. The system of claim 14 wherein said mat is compressed or needle punched.

16. The system of claim 13 wherein said mat comprises reinforcing strands.
